(19) United States
(12) Patent Application Publication
(10) Pub. No.: US 2008/0001968 A1
(43) Pub. Date: Jan. 3, 2008

(54) Layered image compositing system for user interfaces

(76) Inventor: Richard C. Krueger, Raleigh, NC (US)

Correspondence Address: TRIANGLE PATENTS, P.L.L.C., P.O. BOX 28539, RALEIGH, NC, 27611-8539, US

(21) Appl. No.: 11/811,247

(22) Filed: Jun. 8, 2007

Related U.S. Application Data
(63) Continuation of application No. 10/128,378, filed on Apr. 23, 2002, now abandoned.

(51) Int. Cl. G09G 5/00

(52) U.S. Cl. 345/629

(57) ABSTRACT

A system and method for producing computer user interfaces by layered image compositing and procedural imaging. In a preferred embodiment, the present invention provides photorealistic images using compact, efficient software routines that are easily customizable and have full-scalability. The layered image compositing system and method for user interfaces include elements having a pivot coordinate system based on a parent-child relationship and intelligent invalidation mechanism.

### CROSS-REFERENCE TO RELATED APPLICATIONS

This application is a continuation of co-pending U.S. application Ser. No. 10/128,378, filed on Apr. 23, 2002, the entire disclosure of which is incorporated herein by reference in its entirety. Priority to application Ser. No. 10/128,378 is claimed under 35 U.S.C. 120.

### BACKGROUND OF THE INVENTION

(1) Field of the Invention

The present invention relates generally to computer user interfaces and, more particularly, to a procedural image compositing system for user interfaces.

(2) Description of the Prior Art

Prior art skinned user interfaces use simple 24 bit bitmaps to generate and represent the interface. Each user interface element is represented by a two dimensional Cartesian coordinate (x,y) and by a number of bitmaps, which encode the different states the element can be displayed in. Bitmaps store image data and require large amounts of memory even with the best compression techniques available. Skinned user interfaces that contain a large number of bitmaps consume too much memory for real-time Internet transmission. As a result, these interfaces need to be resident on the client computer, rather than downloaded on an as needed basis. In addition, all of the bitmaps that are used by a skinned user interface must be authored using an image editing creation tool or captured using a photographic device. This imposes an artistic overhead on the creator of a skinned user interface over and above simple programming skills. Because of these limitations most programs use simpler graphical user interfaces of the native windowing system rather than skinned user interfaces. Graphical user interfaces are constructed from common abstractions using simple rectangular shapes, with few visual enhancements. These traditional graphical user interfaces have not been extensively enhanced since their introduction in the early 1980s because the PC has been viewed primarily as a productivity tool, not an entertainment device. Because of the emphasis on productivity, graphical user interfaces have been primarily designed to enforce a common set of user interface guidelines and a common look and feel. They require and offer little visual design alternatives to the programmer. However, as personal computers are used increasingly for entertainment purposes, skinned user interfaces are becoming more popular. Skinned user interfaces are better than graphical user interfaces for entertainment software because they attract the attention of the user and entertain him/her, while also potentially conveying an advertising message through better visual branding. Thus, such a skinned user interface will need to be customizable.

One of the requirements for a skinned user interface system is that it allows for easy customization so that a skinned program can support multiple interfaces with different visuals. Architecturally, this means that the skinned user interface, or skin, is specified separately from the program as a resource that is loaded at runtime. Ideally, a skinned program should be able to load a skin from a remote location over the network and have it be delivered “just-in-time” to the user. Therefore the description of a skin must be bandwidth efficient, that is, it minimizes the use of bandwidth for transmission. The skin user interface system must also be memory and processor-efficient, so that only the skin that is displayed is loaded into memory and that it minimizes processor time in order to allow more time for associated content.

Also, the emergence of network appliances, such as digital VCRs connected to the Internet, and especially wireless network appliances has created a new need for user interfaces with better visual characteristics than traditional PC windowing system user interfaces. First, the description of these user interfaces must be as small as possible for faster transmission, especially if transmission occurs via a wireless medium. Similarly, the user interface should be able to be rendered as rapidly as possible, to prevent the user from becoming impatient and possibly stopping the activity because the network appliance, especially an entertainment oriented network appliance, is operating too slowly. Also, because the size of the display on network appliances can vary greatly, the user interface must be truly scalable in order not to lose functionality and esthetic appeal when scaled to large or non-standard displays.

In addition to these technical requirements, these user interfaces must have other qualities that will render them more functionally and esthetically appealing to the user than current graphical user interfaces (GUIs) that are found on most windowing systems. An Internet appliance is frequently used for entertainment purposes, and since advertising supports most entertainment programs, the user interface should be capable of being easily customizable such that new advertising or branding messages can be readily encoded in the user interface.

Currently, traditional graphical user interfaces in windowing systems, such as Microsoft WINDOWS applications, Apple MACINTOSH, or even Unix X-Windows, are based on abstract graphical elements such as scroll bars, drop down menus and rectangular buttons that, in the majority of cases, are drawn using a 16-color palette. Furthermore, the graphical elements are drawn at absolute pixel boundaries, are not anti-aliased, and are generally constrained to rectangular areas on the screen. This type of interface is commonly referred to as a Graphical User Interface (GUI). Traditional Graphical User Interfaces are designed to be lightweight and use a small memory footprint combined with very fast rendering technology. Its simple graphical elements can be drawn very quickly into a single frame buffer—or memory representation of the screen. The reason that these interface elements are considered abstract is that they bear little resemblance to objects in the everyday world, largely because they are composed of simple representations such as lines, rectangles, or ellipses. Traditional GUI's have limited graphics and imaging capabilities. Any images that are displayed in GUIs are usually encoded as bitmaps, edited using an image editor, and displayed in a rectangular area. The use of bitmaps is limited to displaying static image information. In traditional GUIs, the operating system manufacturer is responsible for the visual design of most of the user interface elements so that the programmer can focus on the functionality of his/her program. In fact, traditional graphical user interfaces require little to no artistic design talent on the part of the programmer. As a result, traditional GUIs do not provide extensive procedural imaging or image compositing functions needed to support skinned user interfaces. Procedural imaging uses algorithms to specify image shapes and colors, whereas image compositing assembles an image from discrete, separate images by alpha blending them together. Certainly, traditional GUIs do not provide a way for mixing images together to procedurally create an entire interface, let alone a radical new look.

Entertainment oriented computing requires a user interface technology that is visually more sophisticated than what is provided by a traditional GUI. This is especially true for network appliance level computing, where the look is often more important than the mere functionality of the device. Skinned user interfaces, whose elements are based on image data, are the answer to this problem. They are needed because the windowing systems in traditional GUIs provide few tools to encode and manipulate image data, which is essential to communicate a corporate brand and a diverse set of looks. In fact, traditional GUIs encourage software developers to write programs that conform in both look and functionality to the Operating System's User Interface Guidelines, so that all programs have a uniform look on the screen. However, these same programmers have been severely limited to what they can express visually with the user interface of their program. This limitation is probably acceptable in traditional desktop computing environments with their emphasis on productivity tools, but it is not the case in the entertainment and consumer appliance space, since it is difficult with traditional GUIs to encode brand information or other advertising messages without having to write significant support code to do so.

In traditional skin user interface, which involves composite imaging, image data is rendered hierarchically, with the larger background data being rendered before the foreground data. Thus, a screen will traditionally be rendered starting with the background and then progressing towards the foreground, rendering each component in the order of hierarchy. Elements are then composited together using image alpha blending. Because the background and other near-background objects in user interfaces do not change as frequently as other objects nearer the foreground, these do not need to be rendered as frequently. Therefore, any rendering algorithm used for composite imaging should cache and check the validity of the background and near-background objects when any portion of the screen is being rendered. Such an algorithm should include a validity checking system that reduces rendering times by only rendering those elements that have changed or are affected by a change. Furthermore, if only the user is changing a few interface subcomponents or elements, a properly designed user interface system can allow on-the-fly transformation of screen elements.

Parallel image processing, which capitalizes on today's fast Intel MMX processors, is based on a single instruction multiple data (SIMD) form of parallel processing designed to improve the performance of image processing and graphics. A skin user interface system should take advantage of any SIMD features offered by the processor, such as the MMX instruction set, to speed up image processing and image compositing.

In summary, a need exists for a skin user interface that is memory efficient, requires little bandwidth, is fast rendering, esthetically pleasing, truly scalable, and provides on-the-fly transformation of elements

Thus, there remains a need for a skinned user interface system based on layered image compositing that provides photorealistic look and animation in real time.

### SUMMARY OF THE INVENTION

The present invention is directed to computer user interfaces produced by layered image compositing. In a preferred embodiment, the present invention provides photorealistic images using compact, efficient software routines that are easily customizable and have full-scalability.

Preferably, the layered image compositing system for user interfaces include elements having a pivot coordinate system based on a parent-child relationship and intelligent invalidation mechanism.

The present invention is further directed to a system for generating user interfaces using image compositing routines providing compositing effects by anti-aliasing averaging routines and sub-pixel positioning.

Accordingly, one aspect of the present invention is to provide a computer user interface having photorealistic images and animation in real time.

These and other aspects of the present invention will become apparent to those skilled in the art after a reading of the following description of the preferred embodiment when considered with the drawings.

### BRIEF DESCRIPTION OF THE DRAWINGS

FIG. 1 is a representative view of a set of coordinate systems for an element according to the present invention.

FIG. 2 is a view of a set of coordinate systems superimposed on a computer screen image according to the present invention.

FIG. 3 is a computer screen view of an unmanipulated image.

FIG. 4 is a computer screen view of an image resized and distorted with simple bitmap scaling.

FIG. 5 is a computer screen view of an image resized and distorted according to the present invention.

### DETAILED DESCRIPTION OF THE INVENTION

In the following description, it is to be understood that such terms as “forward,” “rearward,” “front,” “back,” “right,” “left,” “upwardly,” “downwardly,” and the like are words of convenience and are not to be construed as limiting terms.

Skinned interfaces according to the present invention use layered image compositing, procedural imaging, a pivot coordinate system, and intelligent invalidation procedures to produce a user interface that is photorealistic, compact, fast rendering, visually appealing, and easily customizable. Additionally, the user interface elements are described separately from the program using XML and XSLT, thereby making the interface easily customizable.

Skinned interfaces according to the present invention are a new procedural imaging technology that combines effects such as multiple layered semi-transparency, translucency, animation, sub-pixel positioning, anti-aliasing, photo-realism, and layering at the user interface level. A skin-based interface may be understood as a collection of user interface controls, tools, and functions based on a layered image compositing method and an alpha blending model using 32-bit and wider data structures, i.e., a composite image for a user interface. In addition to being able to provide a greater level of photo-realism and design than what is currently possible using conventional graphics for user interfaces, it is also ideally made possible with the fast computer processors not available previously in the art; in other words, it would not have been possible to reasonably employ the system and method of the present invention without the present-day computer processors, i.e., processors with speeds in excess of about 500 MHz and memory capacity in excess of 120 Megabytes of on-board RAM. In a preferred embodiment of the present invention, a computer user interface is produced by procedural imaging and image compositing routines and includes elements that collectively form a composite visual image that is viewable by a computer user on a computer screen, display, or other electronic user interface. Each element in the composite image of the user interface is itself an image. An image is defined as a two-dimensional (2D) array of 32-bit pixel data, 24 bits for the red, green, and blue (RGB) channels and 8 bits for the “alpha” or transparency channel. For example, a button may have an up, a down, and a rollover state, each of which is independently considered an image.

The elements that collectively form the composite visual image include panels, buttons, bitmaps or static images, sliders, tools, and the like.

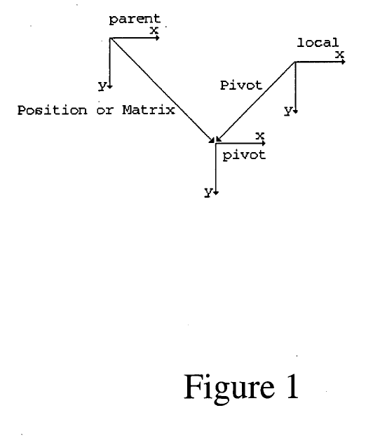

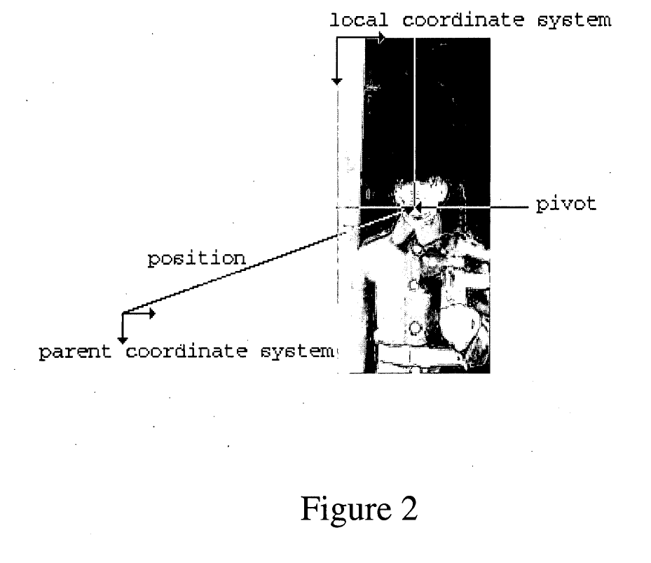

The elements each have corresponding pivot coordinate systems that form the basis for compositing the elements into the composite image. The elements are established by a parent-child relationship of sub-elements, which include a parent element and at least one child, or local, element for each image, which are composited to form the composite image. A pivot coordinate system for each element, as shown in FIGS. 1 and 2, is formed by a matrix and a pivot point that maps a child coordinate space into a parent coordinate space for each element and its sub-elements, respectively. A child element's coordinate system (or local coordinate system) is always relative to its parent element's coordinate system. However, the transformation between coordinate systems involves an intermediate coordinate system known as the ‘pivot’ coordinate system. The pivot coordinate system is necessary in order to preserve a element's center of gravity and alignment.

A control's pivot point is expressed in local coordinates using the Pivot parameter. The pivot point is the origin of the control's pivot coordinate system. The pivot point is also the connection between the parent and the local coordinate system.

The transformation between a local coordinate system and its parent is given by the following formula:

$$[ \begin{matrix}u & v & w\end{matrix} ] = [ \begin{matrix}x & y & 1\end{matrix} ] ⋆ \vert \begin{matrix}1 & 0 & 0 \\ 0 & 1 & 0 \\ - {Pivot}_{x} & - {Pivot}_{y} & 0\end{matrix} \vert ⋆ {Matrix}_{control}$$

$$and$$

$${x}_{parent} = u / w$$

$${y}_{parent} = v / w$$

By way of example, a panel element has a panel element image that is constructed by compositing its child element images in a layered back to front manner.

This pivot coordinate system and mapping of elements according to parent-child relationships provides for an intelligent invalidation mechanism that minimizes the compositing area for each composite image and the element images that form it.

All elements have a 32-bit red-blue-green-alpha (RGB alpha) image that represents their state. This 32-bit image capacity corresponding to each element, combined with the pivot coordinate system set forth hereinabove, provide for the photorealistic image and animation capabilities of the present invention. Every skin user interface element, including by way of example and not limitation, backgrounds, static images, or interface controls, such as buttons or sliders, is a 32-bit image composed of three 8-bit color channels, namely the RGB channels, and an eight bit alpha channel used to control transparency or other compositing effects. Each of the channels may be removed to produce a new effect. It is the combination of the RGB alpha characteristics that define the photorealistic image that forms each element and collectively the composite image of the user interface according to the present invention.

The 8-bit transparency channel provides for a 3-dimensional, photo-realistic effect in the elements and in the overall composite image. This translucent quality is not possible using traditional graphic user interfaces (GUIs), as set forth in the foregoing because traditional GUIs are not based on 32-bit imaging. Alpha-blending as an image compositing routine enables an element to be semi-transparent or opaque. Advantageously, a composite image having transparency characteristics provides one aspect of the photorealistic image quality of the user interface. Programs for computers having such computer user interfaces have better visual design and functionality, e.g., branding of user interfaces for advertising is one novel application of the present invention.

Furthermore, transparency-blending function of the image composting routines according to the present invention also permits the composite image for a user interface to be semi-transparent. Semi-transparency of an entire composite image or portion thereof makes the image less prominent when taken with other images viewable on a computer screen or display or other electronic graphic user interface. This semi-transparency effect is an important feature of the present invention because it allows the user to switch between multiple interfaces on a screen without the un-used screen or screens completely disappearing from view. Thus, using the system and method for providing photorealistic composite images for user interfaces, the user can still see data displayed on other interfaces, while working in another interface. Additionally, because the interfaces are still displayed, albeit transparently, on the computer screen, the user can quickly move to them by simply sliding the computer pointer to the desired interface, rather than moving the pointer to a taskbar or program bar, selecting an interface, and then moving the pointer back to the new interface as it appears. Thus, multiple photorealistic composite user interfaces according to the present invention are more convenient to use than traditional GUIs, as well as more entertaining.

Additionally, every element of the user interface image according to the present invention preferably and advantageously includes an XML or XSLT description, in addition to its C++ based code. The XML or XSLT description allows the programmer to specify the skinned user interface element as a resource separate from the program code. Furthermore, for every new element type defined in another program, e.g., in C++, code automatically generates code to parse its corresponding XML or XSLT description. That is if the programmer defines a new C++ class to implement a new skinned element type, the skinned user interface system according to the present invention will automatically generate the code to parse the element's XML or XSLT description. The skinned user interface system according to the present invention will also generate an XML of XSLT Data Type Definition (DTD) that incorporates the new skinned element.

This preferred embodiment for the system of the present invention advantageously produces a rapid compositing in approximately real time of the photorealistic images in the computer user interfaces generated thereby via utilization of procedural imaging. Procedural imaging utilizes algorithms or equations to describe an image, rather than storing the entire bitmap of the image as a two dimensional array of pixels. Procedural imaging enables a 2-dimensional transformational engine for the generation and transformation of interface elements. The 2D transformational engine/model employed to generated an element can place, scale, and rotate image data anywhere within the compositing space. The 2D engine/model also supports sub-pixel positioning and an animation model for creating smooth transitions over time. Sub-pixel positioning is defined as a method for alpha-blending child elements onto a parent image at floating point pixel positions, as opposed to integer only positions as with prior art. Sub-pixel positioning is required to insure that animations appear smooth over time, rather than ‘jerky’. Thus, the representations of elements and the composite image for user interfaces, according to the present invention are very compact in comparison to traditional bitmap skinned user interface. As such, skinned user interfaces according to the present invention are compact and are ideal for transmission on demand across the Internet using less bandwidth and requiring less time than other bitmap based skinned user interfaces.

Procedural imaging is the preferred method of generating the photorealistic images for computer user interfaces according to the present invention. Procedural imaging is defined as any computational method used to describe an image. It is a method for creating the two dimensional pixel data of an image, as opposed to storing and representing it using a bitmap created from an outside program. Simple procedural imaging would include geometric shapes, text elements, or gradients. More complex forms of procedural imaging would include filters such as drop shadows or embossing. Image compositing is itself a form of procedural imaging because it mathematically manipulates child images at sub-pixel positions by alpha blending them together to compute a parent composite image. The advantage of procedural imaging is that the methods used to describe images include mathematical terms that can be modulated over time, thereby producing smooth animated effects at the user interface level. Also, procedural imaging methods offer a more compact representation because you only need to store the mathematical terms needed to create the image as opposed to pixel data, which can require a great deal of memory.

In a preferred embodiment according to the present invention, the following tools are used for the procedural imaging: fills, shapes, gradients, text paths, and filters and the like. Gradients use interpolation, while paths are different ways to construct an image. Filters can be used for different effects, by way of example and not limitation, to create drop shadows. To create a drop shadow, a target image is blurred and the new blurred image is positioned juxtaposed to the original target image. The present invention, for example, creates drop shadows by blurring the alpha plane of a source image to create a monochrome semi-transparent mask, which is visually blended below the source image. Since the drop shadow is described procedurally, its radius, its color, and its offset can all be animated over time as the user interacts with the interface. Each of the images generated or modified by procedural imaging is scalable using vectors to maintain the photorealistic quality of the composite image. Also, the procedural imaging advantageously provides for a compact representation of the elements and the composite image, since the image is not stored, restored and transferred or transmitted, but rather is created or generated, regenerated, and transmitted based upon procedural imaging, i.e., the composite image is not merely a collection or collage of images themselves, but the routines that represent them. Procedural imaging for transmitting user interfaces is very fast, in fact it is orders of magnitude faster than JPEG image compression format for providing images for user interfaces because it is orders of magnitude more compact; as such, it requires less memory to represent images than with traditional imaging techniques, and requires less bandwidth and is faster to transmit it across a network.

Alternatively, elements or images used to form the composite image for user interfaces can be created with a layered imaging program such as the commercially available Adobe Photoshop. Significantly, such layered imaging cannot be simply transferred to provide a composite user interface on its own in the compact, rapid manner provided for by the present invention. Also, it does not provide for animation or for photorealistic effects of elements, such as asymmetric slider movement. After completion, the layers used to form the image can be saved as different individual elements, and then reassembled at the user interface using the methods and system according to the present invention, i.e., with procedural imaging and image compositing routines consistent with the parent-child element relationships and rendering set forth in this detailed description.

Also, preferably, image compositing routines are employed to provide the photorealistic composite image according to the present invention. Low-level imaging routines, e.g., function name, destination image, source image, source point, clip rectangles, and the like are used for creation and modification of the composite image according to the present invention. This is a key for the functionality of the procedural imaging, because these image compositing routines render the images fast enough to be used real-time. These routines require a processor speed of at least 500 MHz to be generally acceptable, which is why the present invention could not have reasonably been enabled without the processors of present-day computers. Several additional features of the present invention enhance the speed of rendering interfaces and maximize the interface display time, which are uniquely provided by the skinned user interface according to the present invention software functions described herein and the combination with image processing and compositing routines. The 2-dimensional transformational engine that renders the interfaces employs parallel image processing, bottom-up interface revalidation, simultaneous end concatenation, and on-the-fly transformation to speed the rendering of interfaces and maximizes the display time of complete interfaces that provide the photorealistic composite image for user interfaces.

The image compositing routines include MMX-optimized alpha blending to provide different compositing effects, e.g., emboss, inks, lighting effects, and the like. The compositing routines also include an averaging routine for anti-aliasing. Importantly and critically for the preferred embodiment of the present invention, all blending and/or compositing functions operate on sub-pixel positions for each element, including both parent and child elements and sub-elements.

Sub-pixel positioning is an essential component of the present invention. Sub-pixel positioning is defined as the ability to composite or alpha-blend a source image onto a destination image at a non-integer coordinate position. The sub-pixel positioning provides for fast composite image generation. Furthermore, it is sub-pixel positions and blending at a sub-pixel level that provides for smooth animation for the photorealistic composite images for user interfaces according to a preferred embodiment of the present invention.

Skinned interfaces or photorealistic layered composite images for user interfaces according to the present invention also facilitate modification through easier customization than traditional graphical user interfaces. For example, if an interface that carries brands needs to change the displayed brand, only elements of the interface that carry a brand need to be changed. This can be achieved simply by altering the encoding of those specific elements. It is not necessary to edit the entire interface or any of the contiguous areas between these elements and the rest of the interface. This is important if the interface needs to encode company, advertising, or brand information in addition to its functionality. This is also more important in the entertainment and consumer appliance space than in the traditional productivity suites that have long dominated desktop computing.

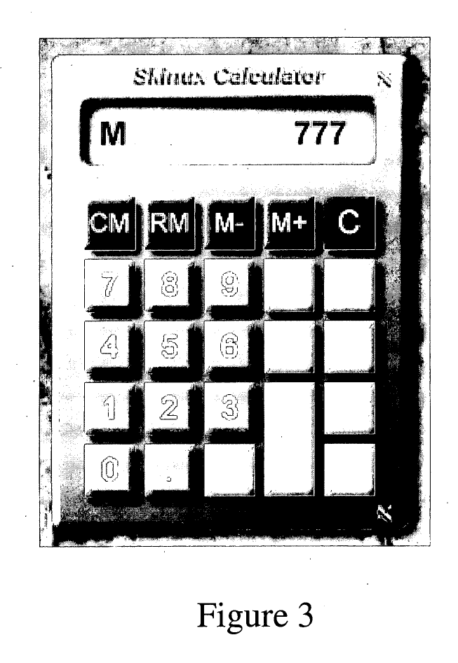

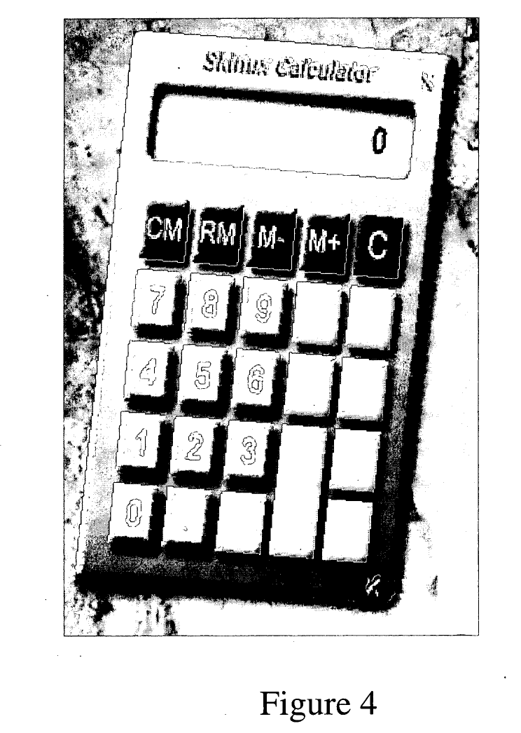

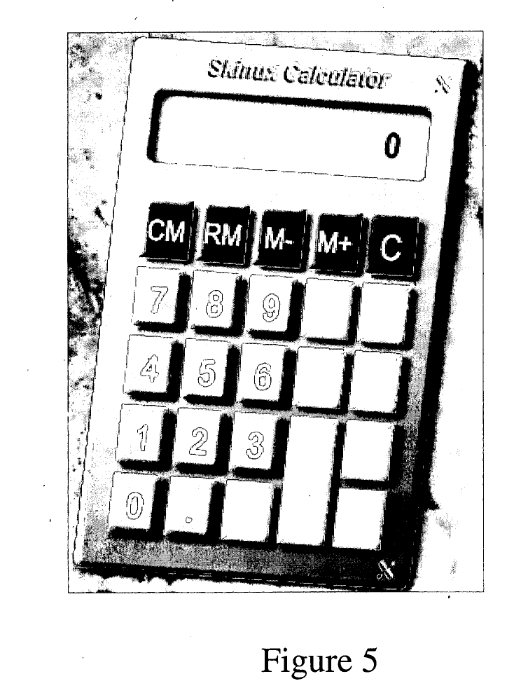

The layered composite image for user interfaces according to the present invention are based on a fully scalable procedural imaging model. Full scalability is possible because of the use of procedural methods for specifying image data, including paths, gradients, patterns, and filters; a 2D transformational model for placing, scaling, and rotating image data anywhere within the compositing space; sub-pixel positioning and an animation model for creating smooth transitions over time; and the description of XML objects as strings using the XML and XSLT stylesheet transformation language. As a result, skinned artwork can be resized and distorted without a loss of clarity or crispness. The layered composite image for user interfaces according to the present invention are not simply encoded by the bitmap representation of a skin control, rather they are encoded by the vector information and the procedural imaging operations used to recreate them. The artwork is rendered to the desired resolution to guarantee a smooth anti-aliased result. For example, consider the Calculator application shown in FIG. 3. If simple bitmap scaling were used and the calculator shown in FIG. 3 is resized, then only pixilated controls would be seen, as shown in FIG. 4. This is because the best bitmap scaling can do is simple bitmap interpolation, be it bilinear or nearest neighbor. A bitmap image does not store path or rendering information, only pixels. On the other hand, the same calculator scaled in the system according to the present invention would not lose its resolution, as shown in FIG. 5, because the present invention renders the image data to any desired size.

Without procedural imaging, when the calculator is scaled, the corresponding element bitmaps would be scaled accordingly. Since bitmap scaling is imprecise, the resulting skinned calculator interface would appear blurry and jaggy, as shown in FIG. 4.

However with procedural imaging all of the elements are scaled mathematically and the skinned user interface is rendered at the new resolution, producing a smooth crisp look at the new size, as shown in FIG. 5.

Total procedural imaging (TPI) is an extension of procedural imaging that requires that the entire skinned user interface be described by procedural imaging and no component of the interface be rendered by graphical techniques, such as bitmapping. This constraint greatly reduces the data requirements for encoding the interface and prevents the creation of interfaces that are excessively large and would take longer to transmit via wireless media. This imaging method allows for user interfaces that are compact, fast rendering, scalable, and rapidly customizable.

A truly scalable skin is esthetically pleasing and is also extremely advantageous as an interface for applications that are also completely scalable. For example, cartoons, be they animated or still, are also being generated using procedural imaging techniques. With progress in procedural imaging techniques and image display techniques, these media will soon be able to be generated with total procedural imaging (TPI), and as such they will be able to be displayed at any magnification without loss of image quality. For example, an animated cartoon generated by TPI for display on a small television screen will also be able to be projected in a theatre without loss of image quality. Conversely, the same animated cartoon can be displayed on a PDA without the need for further image processing, because the image can be scaled down to the size of the smaller appliance. Thus, the totally scalable user interface according to the present invention will allow the display and control of these media in the majority of, if not all, display scales.

Therefore, procedurally encoded interfaces according to the present invention enable an extremely fast image rendering and compositing engine. This engine furthermore utilizes a single instruction multiple data form of parallel processing, bottom-up revalidation, and on-the-fly transformation to further reduce the image-rendering time.

Each element stores a 2-D transformational matrix that allows it to be transformed by a 2-D transformational engine. The 2-D transformational engine according to the present invention utilizes simultaneous end concatenation of linear transformations (SECLT). In SECLT, child elements are transformed into their parents or ancestor coordinate space at the time the image in the parent space is recomputed because of an event that caused an invalidation. The matrix that determines how the child is positioned relative to the parent is computed by concatentating the child's matrix to the parent's matrix. When a parent element has to recomposite an area inside it, the parent instructs each child element associated with that parent to recomposite itself onto the parent's space or ancestor's space. The child needs to concatenate all matrices between itself and the parent to determine where it needs to be placed on the parent. In a preferred embodiment of the present invention, this child recompositing occurs at the moment of compositing. The program used with the system and methods according to the present invention can modify the position of elements, but this modification occurs at the exact time of compositing, i.e., when the child elements are modified, transformed and/or translated into the parent space, if those respective child elements are effected in a recomposited area.

When a user interface element in the hierarchy is transformed, the transformation only is recorded in the matrix of the element that is being transformed. The transformation is not propagated down the hierarchy. Therefore, bitmap elements at the bottom of the hierarchy are not transformed. If they were, the interface would lose clarity because image data cannot be repeatedly transformed without loss of precision and data. Instead, the elements are only transformed into their parent or ancestor space when a parent of ancestor image needs to be recomposited. At this time any intermediate transformed image is computed and composited onto the parent or ancestor image. The intermediate image can be cached for efficiency.

By way of further illustration of the systems and methods according to the present invention, a relational tree or hierarchical relational structure is established with elements that include both parents and children. Each element has a matrix and a respective image. For example, each element, parent P1 and children C2, C3, and C4 have respectively associated therewith a matrix M1 to P, M2 to C2, M3 to C3, and M4 to C4. For transformation of an image, the transformation of the child element C4 into C1's space is represented mathematically by the matrix M4×M3×M2, which is a linear transformation matrix. At the compositing of an image, a transformed image of C4 is produced at a point P in C1's space. As things get changed in the system, corresponding transformations are effected, but importantly, these transformations occur at the time of compositing, according to the present invention. When M1 needs to recomposite a particular area, at the time of recompositing, a computation is made corresponding to that element and its transformation; significantly, the recompositing of P1 and each and every one of its corresponding children that are affected does not occur prior to the image recompositing. If precomputation and advance recompositing occurs for the affected elements, and then an intervening change occurs, then there is an effective invalidation of that precomputation. Thus, for a recompositing according to the mathematical description of controls and parents according to the present invention, controls map into parent space only at the time that M1 on the parent is updating. The compositing routine sends instructions for the children to composite onto the parent. Any lower children in the hierarchy composite upward onto the bitmap or image, which is blended onto the parent matrix M1. At the time of alpha blending or compositing the linear transformation is passed on from the children to the parent. This simultaneous recompositing is important, inasmuch as it provided surprising results: the efficiencies of the present invention are realized when the recompositing of the children happens at the time the parent image is recomposited, because previously, children were compositing in advance, rather than at the time of change, which caused prior compositing invalidation or defective imaging. By way of example, consider a rotating knob moving along a curve; this example for a skinned user interface requires that the knob move or translate and rotate at the same time. According to the present invention, the parent's linear transformation is passed to the child only at the time of compositing. Surprisingly and importantly, with the present invention, no pre-transformation of any of the hierarchy occurs; rather, all modifications are effected simultaneously at the time of recompositing. In other words, the position and orientation of a child is composited relative to its parent only at the time of recompositing of the parent image. The data structure according to the systems and methods of the present invention represents full linear transformations, mathematically speaking, for how a child gets transferred into a parent's space, not merely a simple coordinate transforms for position or simple integer-based coordinate transformation as with prior art systems. Thus, the traditional X-Y coordinate transformational techniques of the prior art do not work for transformation and rotation unless a matrix is employed according to the present invention.

Furthermore, specific element encoding is highly optimized for the Intel MMX processor so that many imaging operations that operate on an image's pixels can take place in parallel. MMX is a critical factor to the present invention. MMX is Intel's standard implementation of a single instruction multiple data (SIMD) form of parallel processing, which greatly speeds up scalar processing. Alpha blending according to the present invention for providing layered composite skinned user interfaces provides for pixel destination with an RGB-alpha (red, blue, green, alpha channels) destination, wherein each is 1 byte, thereby providing a 32-bit channel. By way of example, the following formula provides for a destination image and a source image defined by the parent image equal to the multiplied channels: Pₛ=(Rₛ)(Bₛ)(Gₛ)(alphaₛ). Each image is defined by the pixels inside it. For performing the alpha blending, the source image is aligned onto a destination image. If the source image occurs at a sub-pixel position an intermediate source image is computed at the aligned boundary. For each pixel in the area that onto which an image is being alpha-blended, the destination pixel is defined by R_{d}=(alphaₛ×Rₛ+(1−alphaₛ)R_{d})/255, wherein the alphaₛ is an indication of the level of transparency. If alphaₛ=0, then the destination remains unchanged. Note that for this example, alpha max=255. Significantly, the entire screen on which the user interface is displayed must be created and/or modified by this method, one pixel at a time. For each pixel, assuming the user interface is generated on a data processor having a standard INTEL 80X86 processor, 13 to 42 cycles are required for each multiply instruction; approximately 65 cycles to about 100 cycles are required for the foregoing method or operation for each pixel. Note that there are three (3) colors for one pixel RGB, which provides for about 300 cycles for each pixel for all color channels. For a standard screen or display having about 1 million pixels, about 300 million cycles are necessary for rendering the user interface according to the present invention. Thus, if a 300 MHz computer is used, then 300 million cycles are performed in one second, which is generally not considered fast enough for real time user interface rendering, modification, and displaying changes.

Thus, the present invention importantly includes an MMX architecture, which provides for a 64 bit wide register that can be arranged in a number of ways, e.g., 8 registers from mm0 to mm7. RGB alpha are provided in a 64-bit register, with 16 bits per RGB alpha channel (each). It is possible with the present invention to operate on 4 or 8 at a time. Two (2) computational pipes are available on all INTEL processors (the U-pipe and the V-pipe), so it is possible to perform twice the computations in a given period of time. However, significantly, this requires the recoding of all algorithms in MMX assembler. MMX assembler is hard to use and hard to program, and is not required for most user interfaces, which are generally done in C programming language. As such, using this special MMX assembler for this language, the present invention provides for up to 2 to 4 times the acceleration for any given image processing operation, such as alpha blending, which is important for real-time rendering of skinned user interfaces according to the present invention.

Furthermore, according to the present invention, operations in the imaging library are preprogrammed in MMX assembler language, so that the skinned user interface is utilizable in real time without requiring much more than a 500 MHz MMX machine for performance roughly equivalent to about 2 GHz on a non-MMX machine.

Those sections of elements according to the present invention that are written in MMX assembler often perform between 2 and 4 times faster than the C language equivalents. As a result, the 2-D transformation engine can render and transform imaging elements on-the-fly to support an interactive RMI. Thus, the elements of a user interface according to the present invention render so fast that they can be transformed and displayed as the user is manipulating the same elements and therefore the user does not perceive any lag in the interface. This rapidity of transformation allows for more fluid animation.

As set forth in the foregoing, layered image compositing generates a user interface through the use of multiple, overlying layers, composited to form the final user interface. These multiple layers require a hierarchical precedence of validity checking in order to form the composited final user interface. The 2D transformational engine according to the present invention performs these validity checks and transforms invalid elements using bottom-up revalidation. Thus, the validity checks are performed starting with the lowest ranking component of the hierarchy, that is the foreground and near-foreground and progressing towards the background. Thus, revalidation occurs from the bottom up, or anti-hierarchically, that is, children first, then parents. When a component is found to be invalid, it is recalculated, then the subcomponent only is redrawn on the screen. Therefore, bottom-up revalidation allows re-computing and redrawing of only the altered subcomponent, thereby obviating re-computing the entire image and thus reducing processor time requirements and screen redraw time.

Certain modifications and improvements will occur to those skilled in the art upon a reading of the foregoing description. By way of example, while the UI's described in the foregoing apply to computer display UI, other useful applications include but are not limited to digital VCR interfaces, internet radio interfaces, car dashboards, electronic devices interfaces, etc. All modifications and improvements have been deleted herein for the sake of conciseness and readability but are properly within the scope of the following claims.

I claim:

1. A system for providing skinned user interfaces for computers comprising:
a data processing system including a computer having a main memory, a processor, a display, and an input/output device;
a skinned user interface comprising a composite image produced by procedural imaging and viewable on the computer display by a user;
wherein the composite image is photorealistic and is produced for viewing on the computer display in approximately real time.

2. The system according to claim 1, wherein the composite image is capable of dynamic updates in response to user input.

3. The system according to claim 1, wherein the procedural imaging provides a computational method for describing, generating, and representing the composite image.

4. The system according to claim 1, wherein the composite image is a layered composite image composed of 32-bit elements.

5. The system according to claim 4, wherein the elements include a specifiable pivot coordinate system.

6. The system according to claim 4, wherein the elements are revalidated using a bottom-up revalidation procedure.

7. The system according to claim 4, wherein the elements are encoded in XML.

8. The system according to claim 4, wherein the elements are encoded in XSLT.

9. The system according to claim 3, wherein the procedural imaging includes procedures to produce fills, shapes, gradients, text, paths, and filters.

10. The system according to claim 4, wherein the elements are scalable as vectors.

11. The system according to claim 4, wherein the composite image is composited using image compositing and alpha-blending routines that are optimized for Single Instruction Multiple Data SIMD forms of multi-processing.

12. The system according to claim 11, wherein the compositing routines include routines to produce embossing, inking, max/min, and lighting effects.

13. The system according to claim 11, wherein the compositing routines include an anti-aliasing averaging routine.

14. The system according to claim 11, wherein the compositing routines include sub-pixel positioning.

15. The system according to claim 11, wherein the compositing routines include individual channel operation routines.

16. The system according to claim 11, wherein the compositing routines includes bottom-up interface revalidation.

17. The system according to claim 11, wherein the compositing routines includes simultaneous recompositing.

18. The system according to claim 11, wherein the compositing routines includes on-the-fly transformation.

19. A skinned user interface for computers comprising: a skinned user interface comprising a layered composite image including 32-bit, procedurally encoded elements, wherein the image is composited using image compositing routines making the skinned user interface operable to include dynamic changes in response to user input.

20. The user interface of claim 19, wherein the elements have a specifiable pivot coordinate system.

21. The system according to claim 19, wherein the elements are validity checked using an intelligent invalidation procedure.

22. The system according to claim 19, wherein the elements are encoded in XML.

23. The system according to claim 19, wherein the procedural imaging includes procedures to produce fills, shapes, gradients, text, paths, and filters.

24. The system according to claim 19, wherein the elements are scalable as vectors.

25. The system according to claim 19, wherein the composite image is composited using image compositing and alpha-blending routines that are optimized for Single Instruction Multiple Data SIMD forms of multi-processing.

26. The system according to claim 19, wherein the compositing routines include routines to produce embossing, inking, max/min, and lighting effects.

27. The system according to claim 19, wherein the compositing routines include an anti-aliasing averaging routine.

28. The system according to claim 19, wherein the compositing routines include sub-pixel positioning.

29. The system according to claim 19, wherein the compositing routines include individual channel operation routines.

30. The system according to claim 19, wherein the compositing routines includes bottom-up interface revalidation.

31. The system according to claim 19, wherein the compositing routines includes simultaneous end concatenation of linear transformation.

32. The system according to claim 19, wherein the compositing routines includes on-the-fly transformation.

33. A system for providing skinned user interfaces for computers comprising:
a data processing system including a computer having a main memory, a processor, a display, and an input/output device;
a composite image produced by procedural imaging and viewable on the computer display by a user;
wherein the composite image is photorealistic and is produced for viewing on the computer display in approximately real time.

34. A skinned user interface for computers, comprising: a layered composite image including 32-bit, procedurally encoded elements, wherein the image is composited using image compositing routines.

35. A system for providing skinned user interfaces for computers comprising:
a data processing system including a computer having a main memory, a processor, a display, and an input/output device;
a skinned user interface further comprising a layered composite image of 32-bit elements produced by procedural imaging and viewable on the computer display by a user, wherein the procedural imaging provides a computational method for describing, generating, and representing the composite image and includes procedures to produce fills, shapes, gradients, text, paths, and filters;
wherein the elements comprise a specifiable pivot coordinate system, the elements being revalidated using a bottom-up revalidation procedure, the elements being scalable as vectors and encoded in XML and/or XSLT;
wherein the composite image is composited using image compositing and alpha-blending routines to produce embossing, inking, max/min or lighting effects that are optimized for Single Instruction Multiple Data SIMD forms of multiple processing;
wherein the compositing routines comprise anti-aliasing averaging routine, sub-pixel positioning, individual channel operation routines, bottom-up interface revalidation, simultaneous recompositing, or on-the-fly transformation; and
wherein the composite image is photorealistic and is produced for viewing on the computer display in approximately real time and capable of dynamic updates in response to user input.
